(19) United States
(12) Patent Application Publication
(10) Pub. No.: US 2025/0333237 A1
(43) Pub. Date: Oct. 30, 2025

(54) Closure unit for a bulk material container, container system, emptying station and container emptying system

(71) Applicant: UCON Container System GmbH, Hausach (DE)

(72) Inventors: Ernst ALBACH, Hausach (DE); Ulrich LAUSTER, Schutterwald (DE)

(21) Appl. No.: 19/192,685

(22) Filed: Apr. 29, 2025

(30) Foreign Application Priority Data
Apr. 30, 2024 (EP) 24173531.5

(51) Int. Cl. B65D 88/54; B65B 69/00

(52) U.S. Cl. CPC B65D 88/54; B65B 69/0008

(57) ABSTRACT

Closure unit (24) for a bulk material container (12), comprising
a closure element (26) and
a carrier unit (28) with a carrier element (30) and a emptying opening 34 arranged in the carrier element (30) and having a longitudinal axis of the opening (32).
   wherein the closure element (26) can be moved between a closed position, in which the closure element (26) closes the emptying opening (34), and an open position, in which the closure element (26) at least partially opens the emptying opening (34).
   wherein the carrier unit (28) has container connecting means (36) for non-destructively detachable arrangement of the closure unit (24) on the bulk material container (12),
   and container system (10) with such a closure unit,
   and emptying station (64) for a container system (10),
   and container emptying system with a container system (10) and an emptying station (64).

The invention relates to a closure unit for a bulk material container, a container system, an emptying station and a container emptying system.

Bulk material containers are regularly designed as containers with an integrated outlet funnel, at the tapered end of which an outlet with an outlet opening is arranged. The outlet funnel is usually orientated vertically downwards so that bulk material can flow out of the bulk material container through the outlet opening when the outlet is open.

It is known from the state of the art to use conical closure elements to close the outlet, which are arranged in the outlet funnel of the bulk material container in such a way that the cone tip of the closure element points in the direction of the opening outlet funnel and the edge of the cone base rests circumferentially against the inner wall of the outlet funnel. It is also known from the state of the art to arrange the closing element in the outlet funnel in such a spring-loaded manner that the unactuated closing element closes the outlet and the outlet can be opened by actuating the closing element against the spring force.

For the metered removal of bulk material from bulk material containers, so-called emptying stations are known on which a bulk material container can be placed. Known emptying stations are designed in particular to actuate the closing element by moving it against the spring force.

DE 44 16 009 A1 and DE 198 53 599 A1 are cited as the printed state of the art.

The described emptying stations can only be used with bulk material containers that have an appropriate locking system and an appropriate interface. The dosed removal of bulk goods from a bulk material container, in particular by automated means, therefore requires an appropriately equipped bulk material container. The main disadvantage is that retrofitting bulk material containers with such a closure system is technically and economically complex and therefore unattractive. In fact, it is therefore only possible to remove bulk material from a bulk material container using the known emptying stations for bulk material containers that are intended for use with such an emptying station from the outset and have been equipped accordingly.

The invention is therefore based on the task of providing a system which makes equipping bulk material containers in such a way that they are suitable for use with emptying stations technically simpler and economically more attractive.

The problem is solved according to the invention by a closure unit for a bulk material container with the features of claim 1. In accordance with the invention, the problem is also solved by a container system with the features of claim 9. Furthermore, the problem is solved according to the invention by an emptying station with the features of claim 12. Furthermore, the problem is solved in accordance with the invention by a container emptying system with the features of claim 15.

Advantageous embodiments and further embodiments of the invention are given in the dependent claims.

A closure unit according to the invention for a bulk material container comprises a closure element and a carrier unit with a carrier element and an emptying opening arranged in the carrier element and having a longitudinal axis of the opening. The closure element can be moved between a closed position, in which the closure element closes the emptying opening, and an open position, in which the closure element at least partially opens the emptying opening. In addition, the carrier unit has container connecting means for non-destructively detachable arrangement of the closure unit on the bulk material container. The closure unit designed in this way can be easily retrofitted to the bulk material container. Preferably, the closure element in the closed position rests exclusively on the carrier unit. The closure element is preferably conical in shape and is particularly preferably arranged on the carrier element in such a way that a conical tip of the closure element points away from the carrier element. The carrier element is preferably plate-shaped. The longitudinal axis of the opening can be located in the centre of the emptying opening. Preferably, the closing element can be moved along the longitudinal axis of the opening.

The container connecting means can comprise threaded holes and/or threaded pins, which are preferably arranged on the carrier element.

In a preferred embodiment, the closure element has a closure seal that rests against the carrier element in the closed position. The sealing closing contact is thus made between the closing element and the carrier unit and is therefore independent of the bulk material container. Preferably, the closure seal is arranged radially at one edge of the emptying opening in the closed position, relative to the longitudinal axis of the opening.

The carrier unit can have a flange seal which, in relation to the longitudinal axis of the opening, is arranged radially outside the closure seal. This means that the closure unit can be suitable for different bulk material containers.

Preferably, the flange seal is arranged radially within the container connecting means.

A plunger aligned along the longitudinal axis of the opening can be arranged on the top of the closure element. The plunger is designed to protrude into the bulk material container. This can counteract the formation of bulk goods bridges in the bulk material container. Preferably, the plunger is arranged on the conical tip of the closure element. One end of the plunger opposite the conical tip can be pointed. An arrangement along the longitudinal axis of the opening is referred to here and in the following as an arrangement parallel to or on the longitudinal axis of the opening. Preferably, the plunger is therefore positioned centrally above the emptying opening.

The closure element can have a clamping element, preferably on an underside, for direct interaction with a quick-release system. This allows the closure element to be actuated by means of such a clamping system. The clamping element can be arranged on the longitudinal axis of the opening. Preferably, the clamping element is designed as a clamping pin. The terms “top” and “bottom” refer here and in the following to the intended use of the closure unit. The upper side of the closure element and the lower side of the closure element thus preferably designate opposite sides of the closure element. The clamping element is thus preferably arranged opposite the conical tip of the closure element.

In a further development of the invention, the carrier unit has at least one station connecting means for coupling the closure unit to an emptying station. The at least one station connecting means can be designed as a bore, in particular a threaded bore. In particular, the at least one station connecting means can be designed in such a way that the emptying station can be locked to the at least one station connection means. Preferably, the at least one station connecting means is arranged radially outside the container connecting means in relation to the longitudinal axis of the opening.

A container system according to the invention comprises the closure unit described above and a bulk material container with a container outlet opening and a container flange arranged at the container outlet opening, wherein the container connecting means of the closure unit are arranged at the container flange. In this way, an existing bulk material container can be easily retrofitted with a closure unit. Preferably, the connecting means of the closure unit are compatible with the container flange. The container flange can be designed as a screw flange. Preferably, the connecting means are designed as threaded pins whose positioning corresponds to a hole pattern of the container flange.

The bulk material container is preferably designed as a container with an integrated, preferably conical outlet funnel, at the tapered end of which a container outlet opening is arranged. When the bulk material container is used as intended, the outlet funnel is preferably orientated vertically pointing downwards. The container outlet opening is preferably located at the lowest point of the bulk material container. The bulk material container can comprise a container support structure.

The flange seal is preferably arranged between the container flange and the carrier element so that the connection between the bulk material container and the closure unit can be sealed off from the environment. The diameter of the flange seal can specify a maximum internal diameter of the container outlet opening.

In a preferred embodiment of the invention, the closing element is arranged in the container outlet opening in the closed position. Preferably, the container outlet opening can be sealed towards the emptying opening exclusively by the closure element which, in the closed position, rests against the edge of the emptying opening with the closure seal. The sealing of the container outlet opening to the environment is preferably realised exclusively by means of the flange seal. Preferably, a maximum outer diameter of the closure element is smaller than a minimum inner diameter of the container outlet opening.

Preferably, the closing element is moved further into the bulk material container in the opening position compared to the closing position. This allows a gap to be created between the closure element, in particular the closure seal, and the edge of the emptying opening, so that the closure element at least partially opens the emptying opening.

An emptying station according to the invention, in particular for the container system described above, comprises a station support structure, an emptying unit and a lifting unit. The emptying unit is mounted so that it can be moved relative to the station support structure by means of the lifting unit. The emptying unit also has a system interface for arranging the emptying unit on the container system. The system interface comprises an actuating unit for actuating the container system and at least one connecting means other than the actuating unit for directly connecting the emptying unit to the container system. In particular, the lifting unit can be designed to move the emptying unit vertically.

In a preferred embodiment of the invention, the actuating unit has a quick-release system for direct interaction with the container system. This means that the actuating unit can preferably be coupled directly to the clamping element of the closure unit. An actuating unit of this type can be used to transmit all forces and torques, in particular tensile and compressive forces, from the system interface to the closure element. This eliminates the need to apply spring force to the closure element, as provided for in the prior art. The quick-release system can be designed as a zero-point clamping system.

The at least one connecting means can be designed to fix the position of the emptying station relative to the container system, preferably in all degrees of freedom. Preferably, the at least one connecting means comprises a rotatably arranged locking pin for arranging the emptying unit on the container system. Particularly preferably, the emptying unit can be locked to one of the at least one station connecting means by means of the locking pin. The locking pin can be designed to be rotatable so that the locking pin can be used to create a locking mechanism based on the principle of a bayonet catch. The at least one connecting means can also have the function of aligning the emptying unit in relation to the closure unit.

A container emptying system according to the invention comprises the container system described above and the emptying station described above. The at least one connecting means of the emptying station can be coupled directly to the closure unit, and the closure element can be moved from the closed position to the open position and back by means of the actuating unit. Preferably, the at least one connecting means can be coupled to the closure unit in such a way that the system interface rests against the closure unit, particularly preferably against the underside of the closure element.

The bulk material container can be emptied using the container emptying system described above as follows:

Firstly, the container system can be arranged on the emptying station, preferably by arranging the container support structure on the station support structure. The emptying unit can then be moved in the direction of the container system, i.e. upwards, using the lifting unit. In this way, the system interface can be moved towards the closure unit. As soon as the at least one connecting means enters into operative connection with the at least one station connecting means, the emptying unit can be aligned with respect to the closure unit. The system interface can have at least one proximity sensor, which can be used in particular to detect contact between the system interface and the closure element. Preferably, one of the at least one proximity sensors is arranged directly next to each of the at least one connecting means. As soon as the system interface is in contact with the closure unit, the emptying unit and the closure unit can be coupled together by means of the at least one connecting means.

The actuating unit can then be connected to the closure element, preferably by the quick-release system clamping the clamping element arranged on the closure element. The actuating unit can comprise an actuating drive, for example in the form of an actuating cylinder, by means of which the quick-release system can be moved along the longitudinal axis of the opening. By moving the quick-release system vertically upwards, the closing element can be moved from the closed position to the open position to start the outflow of bulk material through the emptying opening. To stop the outflow of bulk material, the closing element can also be moved downwards from the opening position to the closing position by an opposing vertical movement of the quick-release system. Tensile forces can be transferred from the quick-release system to the closure element.

Once the closure element is back in the closed position, the quick-release system can be opened, the at least one connecting means released and the emptying unit moved away from the container system, i.e. downwards, by means of the lifting unit. Finally, the container system can be removed from the emptying station.

An embodiment of the invention is explained with reference to the following figures. It shows:

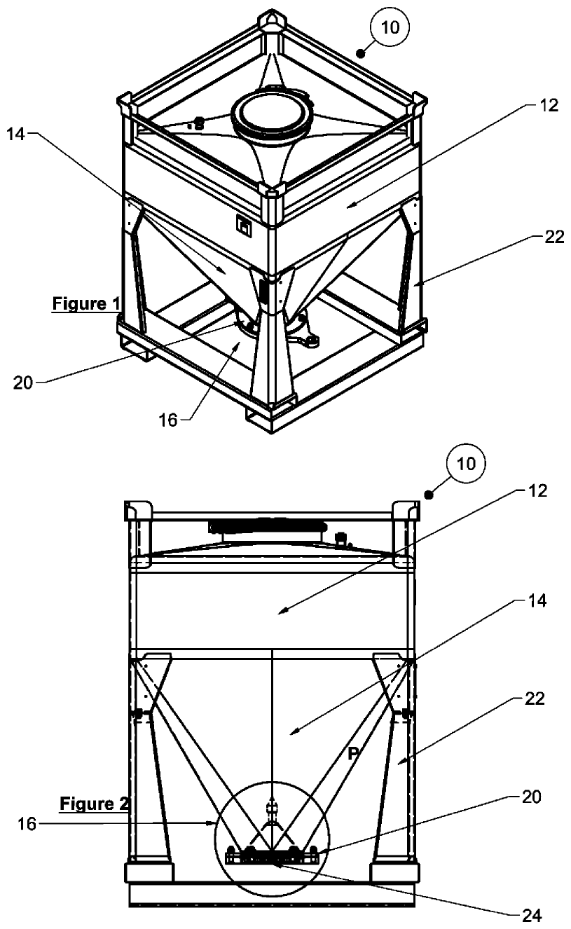

FIG. 1 a perspective view of an example of a container system,

FIG. 2 a side view of the container system shown in FIG. 1 with marked detail P,

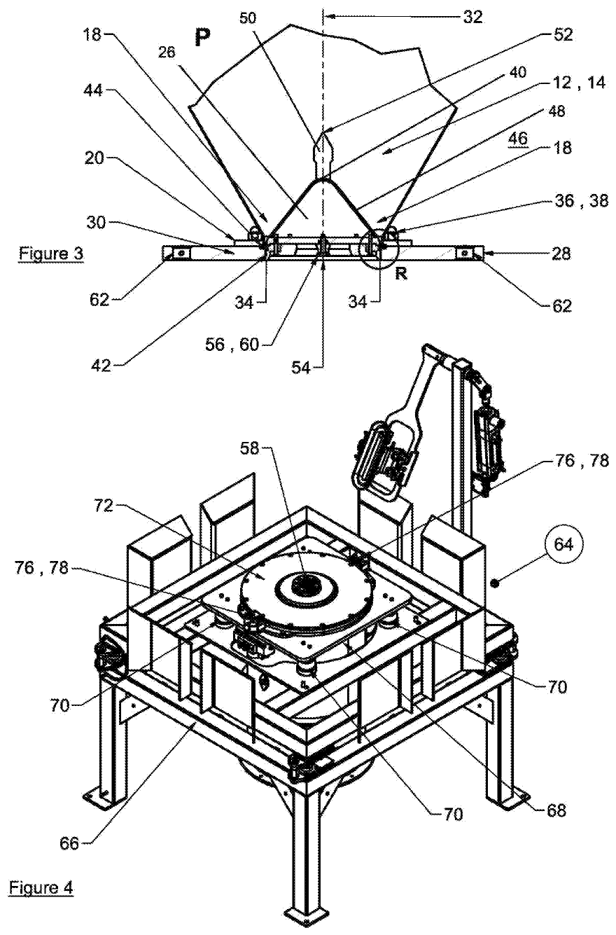

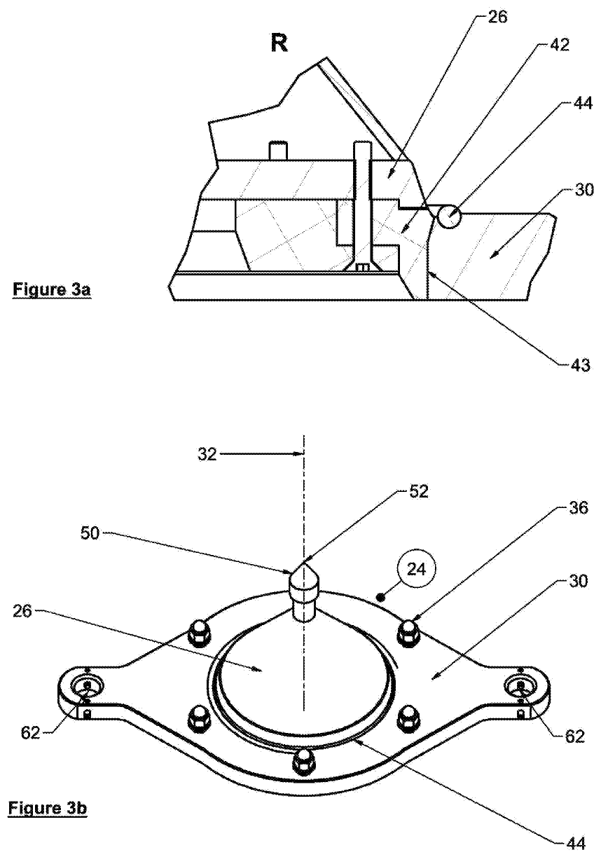

FIG. 3 a partial sectional view of the detail P marked in FIG. 2 with marked detail R,

FIG. 3a a detailed view of the detail R marked in FIG. 3,

FIG. 3b a perspective view of an embodiment of a locking device,

FIG. 4 a perspective view of an example of an emptying station,

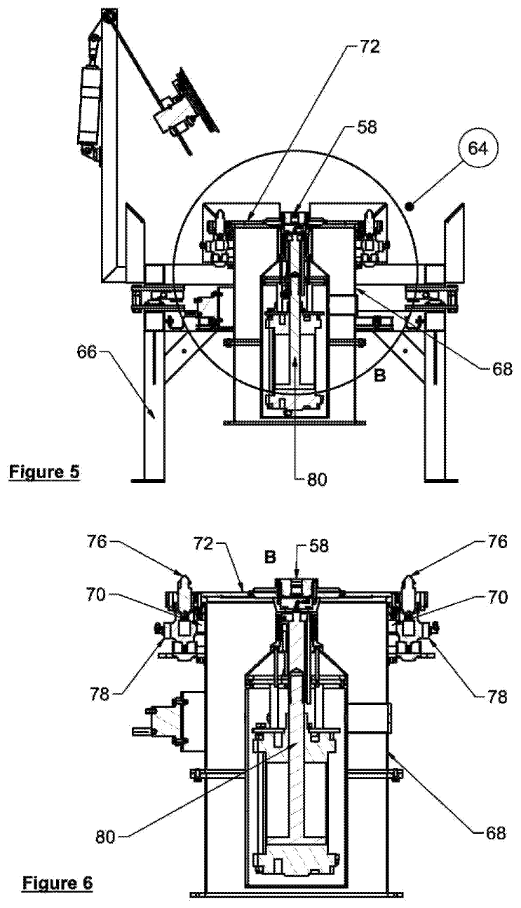

FIG. 5 a sectional view of the emptying station shown in FIG. 4 with marked detail B,

FIG. 6 a detailed view of the detail B marked in FIG. 5.

FIGS. 1 to 6 show various embodiments. The same reference symbols are used for identical and functionally identical parts. For the sake of clarity, not all reference symbols are used in every figure.

FIG. 1 shows a perspective view of a container system 10. The container system 10 comprises a bulk material container 12, which preferably has an integrated, preferably conically shaped outlet funnel 14. A container outlet opening 18 is preferably arranged at a tapered end 16 of the outlet funnel 14. A container flange 20 can in turn be arranged at the container outlet opening 18.

When the bulk material container 12 is used as intended, the outlet funnel 14, as shown in FIG. 1, is preferably orientated vertically pointing downwards. The container outlet opening 18 is preferably located at the lowest point of the bulk material container 12. The illustration in FIG. 1 also shows that the bulk material container 12 can comprise a container support structure 22.

FIG. 2 shows that a closure unit 24 is arranged on the container flange 20, which will be described in more detail below with reference to the views in FIGS. 3, 3a and 3b.

The closure unit 24 comprises a closure element 26 and a carrier unit 28 with a carrier element 30 and a emptying opening 34 arranged in the carrier element 30 and having a longitudinal axis of the opening 32. The closure element 26 can be moved between a closed position, in which the closure element 26 closes the emptying opening 34, and an open position, in which the closure element 26 at least partially opens the emptying opening 34, preferably along the longitudinal axis of the opening 32. FIG. 3-3b show the closing position. In addition, the carrier unit 28 has container connecting means 36, preferably designed as threaded pins and arranged on the carrier element 30, for non-destructively detachable arrangement of the closure unit 24 on the bulk material container 12. FIG. 3 shows that the container connecting means 36 are arranged on the container flange 20 by means of a screw connection 38.

As can be seen in particular from FIGS. 3 and 3b, the closure element 26 is preferably conical in shape and is particularly preferably arranged on the carrier element 30 in such a way that a conical tip 40 of the closure element 26 points away from the carrier element 30. A maximum outer diameter of the closure element 26 is preferably smaller than a minimum inner diameter of the container outlet opening 18. The support element 30 is preferably plate-shaped. The longitudinal axis of the opening 32 can be located in the centre of the emptying opening 34. Preferably, the closing element 26 can be moved along the longitudinal axis of the opening 32.

Preferably, the closure element 26 has a closure seal 42, which rests against the carrier element 30 in the closed position. FIGS. 3 and 3a show that in the closing position shown, the closure element 26 with the closure seal 42 preferably rests exclusively against the carrier unit 28, but not against the bulk material container 12. The sealing closing contact thus takes place between the closure element 26 and the carrier unit 30 and is thus independent of the bulk material container 12. Preferably, the closure seal 42 is arranged radially at one edge 43 of the emptying opening 34 in the closed position, relative to the longitudinal axis of the opening 32.

In the closed position shown in FIGS. 3-3b, the closure element 26 is preferably arranged in the container outlet opening 18. In the open position, the closing element 26 can be moved further into the bulk material container 12 compared to the closed position. This allows a gap to be created between the closure seal 42 and the edge 43 of the emptying opening 34, so that the closure element 26 at least partially clears the emptying opening 34.

The carrier unit 28 can have a flange seal 44 which, in relation to the longitudinal axis of the opening 32, is arranged radially outside the closure seal 42. Preferably, the flange seal 44 is arranged radially within the container connecting means 36. When the closure unit 24 is arranged on the bulk material container 12, the flange seal 44 is preferably arranged between the container flange 20 and the carrier element 30 so that the connection between the bulk material container 12 and the closure unit 24 can be sealed off from the environment 46. The diameter of the flange seal 44 can specify a maximum internal diameter of the container outlet opening 18.

A plunger 50 aligned along the longitudinal axis of the opening 32 can be arranged on an upper side 48 of the closure element 26, which, as FIG. 3 shows, is intended to project into the bulk material container 12. This can counteract the formation of bulk goods bridges in the bulk material container 12. Preferably, the plunger 50 is arranged on the conical tip 40 of the closure element 26. Preferably, the plunger 50 is therefore positioned centrally above the emptying opening 34. One end 52 of the plunger 50 opposite the conical tip 40 can be pointed.

A clamping element 56 can be arranged on an underside 54 of the closure element 26 for direct interaction with a quick-release system 58. The clamping element 56 can be arranged on the longitudinal axis of the opening 32. The clamping element 56 is thus preferably arranged opposite the conical tip 40 of the closure element 26. Preferably, the clamping element 56 is designed as a clamping pin 60.

The carrier unit 28 can have several station connecting means 62 in the form of a bore, in particular a threaded bore, for coupling the closure unit 24 to an emptying station 64. Each of the station connecting means 62 can be designed such that the emptying station 64 can be interlocked with the respective station connecting means 62. Preferably, the station connecting means 62 are arranged radially outside the container connecting means 36 with respect to the longitudinal axis of the opening 32.

The emptying station 64, in particular for the container system 10 described above, is shown in FIGS. 4-6. The emptying station 64 comprises a station support structure 66, an emptying unit 68 and a lifting unit 70. The emptying unit 68 is mounted so that it can be moved, preferably vertically, relative to the station support structure 66 by means of the lifting unit 70. The emptying unit 68 also has a system interface 72 for arranging the emptying unit 68 on the container system 10.

As can be seen in particular in FIGS. 4 and 5, the system interface 72 comprises an actuating unit 74 for actuating the container system 10 and preferably two connecting means 78, each comprising a locking pin 76, which are different from the actuating unit 72 and are for directly connecting the emptying unit 68 to the container system 10. The actuating unit 74 comprises the quick-release system 58, with which it can preferably be coupled directly to the clamping pin 60 of the closure unit 24.

The position of the emptying station 64 relative to the container system 10 can be fixed in all degrees of freedom by means of the locking pins 76. Both locking pins 76 can be designed to be rotatable, so that each of the locking pins 76 can be used to produce a locking mechanism according to the principle of a bayonet catch. The locking pins 76 can also be used to align the emptying unit 68 relative to the closure unit 24.

A container emptying system comprises the container system 10 and the emptying station 64. The locking pins 76 of the emptying station 64 can be coupled directly to the station connecting means 62, and the closure element 26 can be moved from the closed position to the open position and back by means of a vertical movement of the actuating unit 74. For this purpose, the actuating unit 74 can have an actuating cylinder 80. Preferably, the locking pins 76 can be coupled to the closure unit 24 in such a way that the system interface 72 rests against the closure unit 24, particularly preferably against the underside 54 of the closure element 26.

Emptying the bulk material container 12 with the container emptying system can be carried out as follows:

Firstly, the container system 10 can be arranged on the emptying station 64, preferably by arranging the container support structure 22 on the station support structure 66. The emptying unit 68 can then be moved in the direction of the container system 10, i.e. upwards, using the lifting unit 70. In this way, the system interface 72 can be moved towards the closure unit 24. As soon as the locking pin 76 enters into operative connection with the at least one station connecting means 62, the emptying unit 68 can be aligned with respect to the closure unit 24. As soon as the system interface 72 is in contact with the closure unit 24, the emptying unit 68 and the closure unit 24 can be coupled together by means of the locking pins 76.

The actuating unit 74 can then be connected to the closure element 26, preferably by the quick-release system 58 clamping the clamping pin 60. The closing element 26 can be moved from the closed position shown in FIG. 3 to the open position by moving the quick-release system 58 upwards along the longitudinal axis of the opening 32 by means of the actuating cylinder 80 in order to start the outflow of bulk material through the emptying opening 34. To stop the outflow of bulk material, the closing element 26 can also be moved downwards from the opening position to the closing position by an opposing vertical movement of the quick-release system 58. Tensile forces can be transferred from the quick-release system 58 to the closure element 26.

Once the closure element 26 is back in the closed position, the quick-release system 58 can be opened, the locking pins 76 released and the emptying unit 68 moved away from the container system 10, i.e. downwards, by means of the lifting unit 70. Finally, the container system 10 can be removed from the emptying station 64.

### LIST OF REFERENCE SYMBOLS

10 Container system
12 Bulk material container
14 Outlet funnel
16 Tapered end
18 Container outlet opening
20 Container flange
22 Container support structure
24 Closure unit
26 Closure element
28 Carrier unit
30 Carrier element
32 Longitudinal axis of the opening
34 Emptying opening
36 Container connecting means
38 Screw connection
40 Cone tip
42 Closure seal
43 Edge
44 Flange seal
46 Environment
48 Top side
50 Plunger
52 End
54 Underside
56 Clamping element
58 Quick-release system
60 Clamping pin
62 Station connecting means
64 Emptying station
66 Station support structure
68 Emptying unit
70 Lifting unit
72 System interface
74 Actuating unit
76 Locking pin
78 Connecting means
80 Actuating cylinder

1. Closure unit (24) for a bulk material container (12), comprising
a closure element (26) and
a carrier unit (28) with a carrier element (30) and a emptying opening 34 arranged in the carrier element (30) and having a longitudinal axis of the opening (32),
wherein the closure element (26) can be moved between a closed position, in which the closure element (26) closes the emptying opening (34), and an open position, in which the closure element (26) at least partially opens the emptying opening (34),
wherein the carrier unit (28) has container connecting means (36) for non-destructively detachable arrangement of the closure unit (24) on the bulk material container (12).

2. Closure unit according to claim 1, characterised in that the container connecting means (36) comprise threaded holes and/or threaded pins.

3. Closure unit according to claim 1, characterised in that the closure element (26) has a closure seal (42) which rests against the carrier element (28) in the closed position.

4. Closure unit according to claim 3, characterised in that the carrier unit (28) has a flange seal (44) which, in relation to the longitudinal axis of the opening (32), is arranged radially outside the closure seal (42).

5. Closure unit according to claim 1, characterised in that a plunger (50) aligned along the longitudinal axis of the opening (32) is arranged on an upper side (48) of the closure element (26).

6. Closure unit according to claim 1, characterised in that the closure element (26) has, preferably on an underside (54), a clamping element (56) for direct interaction with a quick-release system (58).

7. Closure unit according to claim 1, characterised in that the carrier unit (28) comprises at least one station connecting means (62) for coupling the closure unit (24) to an emptying station (64).

8. Closure unit according to claim 7, characterised in that the at least one station connecting means (62) is arranged radially outside the container connecting means (36) in relation to the longitudinal axis of the opening (32).

9. Container system (10) comprising a closure unit (24) according to claim 1 nd a bulk material container (12) with a container outlet opening (18) and a container flange (20) arranged at the container outlet opening (18), wherein the container connecting means (36) of the closure unit (24) are arranged at the container flange (20).

10. Container system according to claim 9, characterised in that the closure element (26) is arranged in the container outlet opening (18) in the closed position.

11. Container system according to claim 9, characterised in that the closure element (26) is displaced further into the bulk material container (12) in the opening position compared to the closing position.

12. Emptying station (64) for a container system (10), in particular according to claim 9, with a station support structure (66), an emptying unit (68), and a lifting unit (70),
wherein the emptying unit (68) is mounted so as to be displaceable relative to the station support structure (66) by means of the lifting unit (70),
wherein the emptying unit (68) has a system interface (72) for arranging the emptying unit (68) on the container system (10), and
wherein the system interface (72) comprises an actuation unit (74) for actuating the container system (10),
characterised in that the system interface (72) has at least one connecting means (78), different from the actuating unit (74), for directly connecting the emptying unit (68) to the container system (10).

13. Emptying station according to claim 12, characterised in that the actuating unit (74) has a quick-release system (58) for direct interaction with the container system (10).

14. Emptying station according to claim 12, characterised in that the at least one connecting means (78) comprises a rotatably arranged locking pin (76) for arranging the emptying unit (68) on the container system (10).

15. Container emptying system having a container system (10) according to claim 9 and an emptying station (64), characterised in that the at least one connecting means (78) of the emptying station (64) can be coupled directly to the closure unit (24), and the closure element (26) can be moved from the closed position into the open position and back by means of the actuating unit (74).
